(19) United States
(12) Patent Application Publication
(10) Pub. No.: US 2012/0105359 A1
(43) Pub. Date: May 3, 2012

(54) RESISTIVE TOUCH SCREEN

(75) Inventors: Youn Soo Kim, Seoul (KR); Yong Hyun Jin, Seoul (KR); Ji Soo Lee, Gyunggi-do (KR)

(73) Assignee: SAMSUNG ELECTRO-MECHANICS CO., LTD., Gyunggi-do (KR)

(21) Appl. No.: 13/020,993

(22) Filed: Feb. 4, 2011

(30) Foreign Application Priority Data
Oct. 29, 2010 (KR) 1020100107204

(51) Int. Cl. G06F 3/045

(52) U.S. Cl. 345/174

(57) ABSTRACT

Disclosed herein is a resistive touch screen, including: a lower substrate formed with a lower electrode pattern unit made of a conductive polymer and a lower electrode wiring unit connected to the lower electrode pattern unit; an upper substrate disposed on the upper side of the lower substrate and formed with an upper electrode pattern unit made of a conductive polymer and an upper electrode wiring unit connected to the upper electrode pattern unit, formed on an opposite surface thereto; a spacer disposed between the lower substrate and the upper substrate and provided with an opening formed therein; and a surface modifying layer covering at least any one of the lower electrode pattern unit and the upper electrode pattern unit and made of a material having a work function smaller than the conductive polymer.

### CROSS REFERENCE TO RELATED APPLICATION

This application claims the benefit of Korean Patent Application No. 10-2010-0107204, filed on Oct. 29, 2010, entitled “Resistive Touch Screen” which is hereby incorporated by reference in its entirety into this application.

### BACKGROUND OF THE INVENTION

1. Technical Field

The present invention relates to a resistive touch screen.

2. Description of the Related Art

With the development of a mobile communication technology, user terminals such as cellular phones, PDAs, and navigations can serve as a display unit that simply displays character information as well as a unit for providing various and complex multi-media such as audio, moving picture, radio internet web browser, etc. Due to a recent demand for a larger display screen within a terminal having a limited size, a display scheme adopting a touch screen has been more in the limelight. The touch screen integrates a screen and coordinate input units, thereby making it possible to save a space as compared to a key input scheme according to the prior art.

Currently, the type of touch screen mainly used is largely classified into two types.

First, a capacitive touch screen has a structure in which an upper substrate formed with a first electrode pattern having a first directionality and a lower substrate formed with a second electrode pattern having a second directionality are spaced apart from each other and an insulator is inserted therebetween in order to prevent the first electrode pattern from contacting the second electrode pattern.

As an input unit touches a touch screen, the capacitive touch screen measures a change in capacitance generated from the first electrode pattern and the second electrode pattern to calculate the coordinates of a touched point.

A resistive touch screen is configured in which an upper substrate formed with an upper electrode pattern and a lower substrate formed with a lower electrode pattern are spaced apart from each other by a spacer and are disposed to be in contact with each other by external pressure. When an upper substrate formed with an upper electrode pattern is pressed by an input unit such as fingers, pens or the like, the upper/lower electrode patterns are conducted and a change in voltage according to a change in resistance value of the positions is recognized by a controller, such that the touched coordinates are detected.

The electrode pattern according to the prior art is generally made of a transparent conductive material such as a metal oxide (representatively, ITO). However, the metal oxide including the rare earth metals is expensive and the resource deposits thereof are limited.

Research into a conductive polymer has recently been conducted in order to replace the metal oxide. The conductive polymer has an advantage capable of supplementing demerits of the metal oxide; however, it also has several problems.

In particular, the conductive polymer has a high work function which is a minimum energy required in drawing out one of electrons in a material to the outside.

The upper/lower electrode patterns of the resistive touch screen become in contact with each other by external pressure to generate movement of electrons, and as a result, they are conducted and the coordinates of the touched points are calculated based thereon. However, in the resistive touch screen including the electrode patterns made of the conductive polymer, a higher voltage and stronger external pressure are required for the movement of the electrons.

### SUMMARY OF THE INVENTION

The present invention has been made in an effort to provide a resistive touch screen further includes a surface modifying layer covering electrode patterns and made of a material having a work function smaller than a conductive polymer to improve touch sensitivity even at a low voltage and a low external pressure.

According to a preferred embodiment of the present invention, there is provided a resistive touch screen, including: a lower substrate formed with a lower electrode pattern unit made of a conductive polymer and a lower electrode wiring unit connected to the lower electrode pattern unit; an upper substrate disposed on the upper side of the lower substrate and formed with an upper electrode pattern unit made of a conductive polymer and an upper electrode wiring unit connected to the upper electrode pattern unit, formed on an opposite surface thereto; a spacer disposed between the lower substrate and the upper substrate and provided with an opening formed therein; and a surface modifying layer covering at least any one of the lower electrode pattern unit and the upper electrode pattern unit and made of a material having a work function smaller than the conductive polymer.

The conductive polymer may be any one of polythiophene, polypyrrole, polyaniline, polyacetylene, and polyphenylene polymers.

The surface modifying layer may be made of any one of cesium fluoride (CsF), cesium carbonate (Cs₂Co₃) and potassium carbonate (K₂CO₃).

The resistive touch screen may further include a window bonded to the upper side of the upper substrate.

The spacer may be made of a double-bonded sheet.

The lower electrode pattern unit may include a plurality of lower electrode patterns extended in a first direction, wherein the plurality of lower electrode patterns are arranged in a second direction, and the upper electrode pattern unit may include a plurality of upper electrode patterns extended in a second direction, wherein the plurality of upper electrode patterns are arranged in a first direction.

### BRIEF DESCRIPTION OF THE DRAWINGS

FIG. 1 is a cross-sectional view of a resistive touch screen according to an exemplary embodiment of the present invention;

FIG. 2 is an exploded perspective view explaining a configuration of the resistive touch screen of FIG. 1;

FIG. 3 is a graph briefly describing a work function of an electrode pattern unit and a surface modifying layer; and

FIGS. 4 and 5 are cross-sectional views briefly describing a resistive touch screen according to another preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

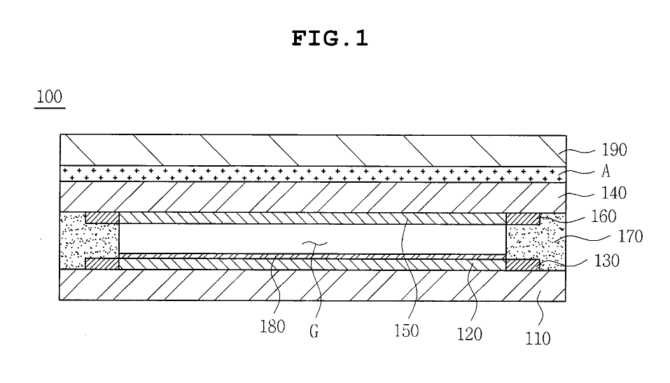

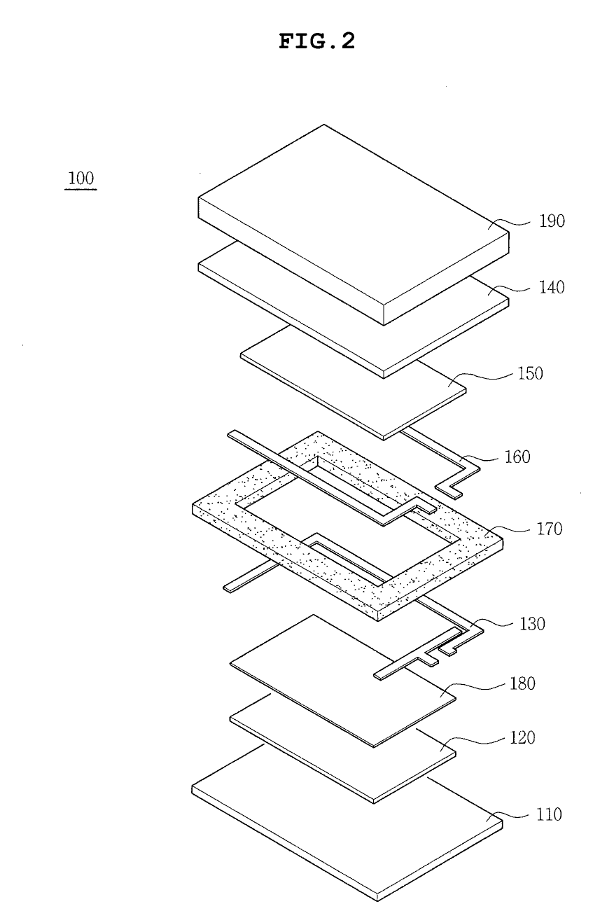

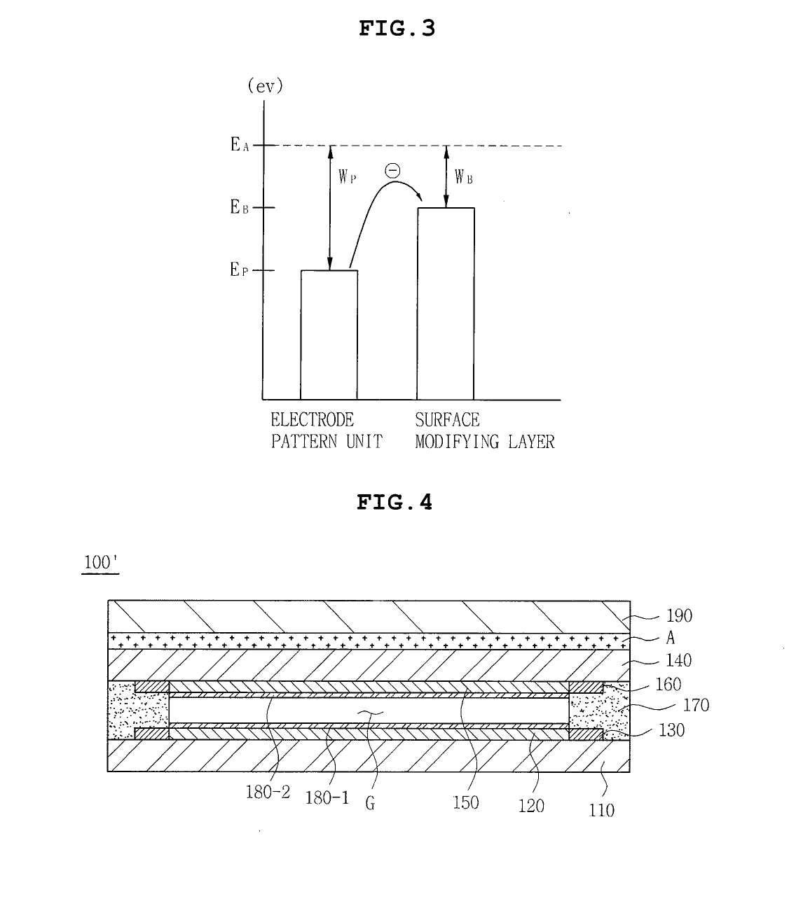

FIG. 1 is a schematic cross-sectional view of a resistive touch screen according to an exemplary embodiment of the present invention; FIG. 2 is an exploded perspective view explaining a configuration of the resistive touch screen of FIG. 1, and FIG. 3 is a graph briefly describing a work function of an electrode pattern unit and a surface modifying layer. Hereinafter, a resistive touch screen (hereinafter, referred to as a touch screen) according to the present embodiment will be described with reference to these figures.

In the resistive touch screen 100 (hereinafter, referred to as a touch screen) according to the present embodiment, two substrates formed with electrode pattern units 120 and 150 made of a conductive polymer and electrode wiring units 130 and 160 are coupled by a spacer 170 to be opposite to each other, as shown in FIGS. 1 and 2. The touch screen includes a surface modifying layer 180 covering any one of the electrode pattern units 120 and 150 and made of a material having a smaller work function than that of the conductive polymer.

FIGS. 1 and 2 exemplarily illustrate an analog resistive touch screen. In such a touch screen 100, the film-shaped electrode pattern units 120 and 150 (generally called ‘resistive film’) are formed in an active region through which an image passes and the electrode wiring units 130 and 160 formed of two electrode wirings are formed on the lower substrate 110 and the upper substrate 140 in an inactive region surrounding the active region.

The lower substrate 110 and the upper substrate 140, which are transparent members, may use a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefin copolymer (COC), stylene polymer, etc., and is not specifically limited.

As the upper substrate 140, polyethylene terephthalate (PET) is generally used and as the lower substrate 110, a glass substrate may be used, as needed.

In addition, the film-shaped electrode pattern units 120 and 150 formed on the upper surface of the lower substrate 110 and formed on the lower surface of the upper substrate 140 are formed to be opposite to each other. The film-shaped electrode pattern units 120 and 150 may be formed by applying a conductive polymer solution to the substrate and drying or printing it.

In this case, the electrode pattern units 120 and 150 may be made of the conductive polymer, wherein the conductive polymer may adopt polythiophene, polypyrrole, polyaniline, polyacetylene, polyphenylene polymers, etc. as organic compounds. In particular, among the polythiophene-based compounds, a PEDOT/PSS compound is most preferable and one or more kinds of compounds among the organic compounds may be mixed and used. In addition, when carbon nanotube or the like is further mixed, conductivity may be further enhanced.

The conductive polymer is advantageous in that the manufacturing costs is inexpensive as compared to the metal oxide according to the prior art and the mass-production thereof is possible.

The electrode wiring units 130 and 160 connected to the film-shaped electrode pattern units 120 and 150 are formed in the inactive region of the lower substrate 110 and the upper substrate 140. The electrode wiring units 130 and 160 are made of metal having low resistance (in particular, silver paste), wherein the lower electrode wiring unit 130 and the upper electrode wiring unit 160 have directionalities intersecting with each other. As shown in FIGS. 1 and 2, in a 4-wire touch screen, the lower electrode wiring unit 130 is conducted at both sides of the electrode pattern unit 120 and the upper electrode wiring unit 160 is conducted with the upper electrode pattern unit 150 in a direction intersecting with the lower electrode wiring, thereby transferring a change in voltage depending on an external touch to a controller.

The electrode wiring units 130 and 160 may be formed by a photolithography scheme, an inkjet printing scheme, a gravure printing scheme, or the like.

The spacer 170 has a shape in which an opening is formed so that the upper electrode pattern unit 150 is able to be in contact with the lower electrode pattern unit 120 when the warpage of the upper substrate 140 is caused by external pressure. The spacer 170 may bond the upper substrate 140 to the lower substrate 110 using a separate adhesive, after being molded using a plastic resin. However, the spacer 170 may be preferably made of a double-sided adhesive sheet in consideration of easiness in manufacturing thereof

The touch screen 100 according to the present invention includes a surface modifying layer 180 covering any one of the electrode pattern units 120 and 150 and made of a material having a smaller work function than that of the conductive polymer.

Electrons in atoms have different energy depending on positions thereof Electrons have lower energy in a direction towards the nucleus. When electrons begin to fill from a low energy level, a difference in energy required for a single electron to move between the highest level (Fermi level) in which the electrons are full and a level outside a material is called a work function. It is generally measured in eV (electron volts). 1 eV is work or energy required when an electron moves by 1 V of potential difference.

It may be appreciated from FIG. 3 that a work function W_{B} required when an electron moves between the level E_{B} of the surface modifying layer 180 and a level E_{A} outside is smaller than a work function Wₚ between the level Eₚ of the electrode patterns made of the conductive polymer and the level E_{A} outside.

In the touch screen according to the present invention, when the electrons move between the lower electrode pattern unit 120 and the upper electrode pattern unit 150, the electrons move to the surface modifying layer 180 and then move to the electrode pattern units 120 and 150 to reduce the work function, thereby making it possible to reduce input voltage and reduce the strength from external pressure.

The surface modifying layer 180 may preferably be made of any one of cesium fluoride (CsF), cesium carbonate (Cs₂Co₃) and potassium carbonate (K₂CO₃); however, is not limited thereto and is made of a material having a work function smaller than the conductive polymer, thereby making it possible to accomplish the object of the present invention.

Meanwhile, although not shown in FIGS. 1 and 2, a dot spacer made of an insulating synthetic resin such as an epoxy, an acrylic resin, or the like. may be formed on the electrode pattern unit 150 or the surface modifying layer 180, in order to prevent malfunction of the touch screen.

In addition, the touch screen 100 according to the present invention may further include a window 190 formed on the upper side of the upper substrate 140, as shown in FIGS. 1 and 2.

The window 190 provides a touched surface protecting the touch screen 100 and touched by an input unit. The window 190 may adopt a transparent film substrate (in particular, polymethylemethacrylate (PMMA), polycarbonate (PC)) or a glass substrate (in particular, tempered glass), having excellent durability. The window 190 is bonded to the upper substrate 140 of the resistive touch screen by a transparent adhesive A such as an optical clear adhesive (OCA).

Although not shown in FIGS. 1 and 2, a covering film may be formed in an outer region of the upper surface or lower surface of the window 190. When the electrode wiring units 130 and 160 are made of metal such as silver paste, the electrode wiring units 130 and 160 may be recognized outside. In order to prevent this, the covering film may be formed. The covering film may be formed by printing ink having low brightness, for example, black ink, in the outer region of the window 190.

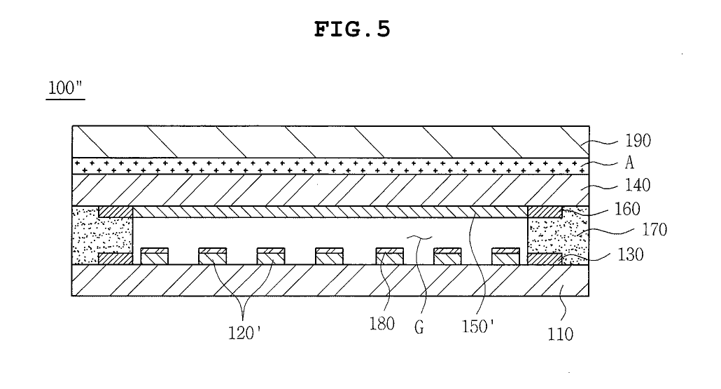

In another touch screen 100′ according to the present invention, surface modifying layers 180-1 and 180-2 may also be formed to cover the lower electrode pattern unit 120 and the upper electrode pattern unit 150, respectively, as shown in FIG. 4.

In this case, the surface modifying layer 180 covers the electrode pattern units 120 and 150 made of the conductive polymer, wherein the surface modifying layer 180 serves to protect the electrode pattern units 120 and 150 from moisture infiltrated into an air gap G as well as lower the work function.

In the resistive touch screen, the moisture infiltrated into the air gap G leads to modification of the electrode pattern units 120 and 150 made of the conductive polymer. In particular, the conductive polymer has a problem in that sheet resistance is changed according to moisture.

The present invention includes the surface modifying layer 180 covering the electrode pattern units 120 and 150 to prevent the moisture infiltrated into the air gap G from directly contacting the electrode pattern units 120 and 150, thereby making it possible to minimize the modification of the electrode pattern units 120 and 150.

A touch screen 100″ according to still another embodiment of the present invention may also be configured of a digital resistive touch screen, as shown in FIG. 5. Different from the analog resistive touch screen including the film-shaped electrode pattern units 120 and 150, the digital resistive touch screen includes a plurality of patterned electrode patterns and thus, increases the number of electrode wirings accordingly.

A lower electrode pattern unit 120′ includes a plurality of lower electrode patterns extended in a first direction, wherein the plurality of lower electrode patterns are arranged in a second direction, and an upper electrode pattern unit 150′ includes a plurality of upper electrode patterns extended in a second direction, wherein the plurality of upper electrode patterns are arranged in a first direction.

In this case, the first direction may be defined as an X direction, a Y direction, or a diagonal direction, and the second direction may be defined as a direction intersecting with the first direction. In particular, the first direction and the second direction may more preferably have directionalities orthogonal to each other.

When a plurality of points are touched, the digital resistive touch screen 100″ includes a plurality of electrode patterns to measure a change in voltage changed on each of the electrode patterns, thereby obtaining coordinate information. The method of obtaining coordinate information of the digital resistive touch screen has been publicly known and thus a detailed description thereof will be omitted.

In the digital resistive touch screen 100″, the upper portion of the electrode patterns is also covered by the surface modifying layer 180, such that when electrons pass through the surface modifying layer 180 having a low work function, while moving, and as a result, the electrons easily move even at low input voltage.

In FIG. 5, the surface modifying layer 180 is described to cover only the lower electrode pattern unit 120′; however, it may also be formed to further cover the upper electrode pattern unit 150′ as shown in FIG. 4.

The resistive touch screen according to the present invention further includes a surface modifying layer made of a material having a work function smaller than a conductive polymer configuring electrode pattern units, thereby making it possible to improve touch sensitivity even at a low voltage and a low external pressure.

In addition, the surface modifying layer protects the electrode pattern units from moisture infiltrated into the air gap to constantly maintain sheet resistance of the electrode pattern units, thereby making it possible to improve reliability of the touch screen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A resistive touch screen, comprising:
a lower substrate formed with a lower electrode pattern unit made of a conductive polymer and a lower electrode wiring unit connected to the lower electrode pattern unit;
an upper substrate disposed on the upper side of the lower substrate and formed with an upper electrode pattern unit made of a conductive polymer and an upper electrode wiring unit connected to the upper electrode pattern unit, formed on an opposite surface thereto;
a spacer disposed between the lower substrate and the upper substrate and provided with an opening formed therein; and
a surface modifying layer covering at least any one of the lower electrode pattern unit and the upper electrode pattern unit and made of a material having a work function smaller than the conductive polymer.

2. The resistive touch screen as set forth in claim 1, wherein the conductive polymer is any one of polythiophene, polypyrrole, polyaniline, polyacetylene, and polyphenylene polymers.

3. The resistive touch screen as set forth in claim 1, wherein the surface modifying layer is made of any one of cesium fluoride (CsF), cesium carbonate (Cs₂Co₃) and potassium carbonate (K₂CO₃).

4. The resistive touch screen as set forth in claim 1, further comprising a window bonded to the upper side of the upper substrate.

5. The resistive touch screen as set forth in claim 1, wherein the spacer is made of a double-bonded sheet.

6. The resistive touch screen as set forth in claim 1, wherein the lower electrode pattern unit includes a plurality of lower electrode patterns extended in a first direction, the plurality of lower electrode patterns being arranged in a second direction, and the upper electrode pattern unit includes a plurality of upper electrode patterns extended in a second direction, the plurality of upper electrode patterns being arranged in a first direction.
